(19) United States
(12) Patent Application Publication
(10) Pub. No.: US 2025/0218644 A1
(43) Pub. Date: Jul. 3, 2025

(54) Coupled Dual Winding Structure and Inductor

(71) Applicants: HUIZHOU POCO NEW INDUCTOR TECHNOLOGY CO., LTD., Huizhou (CN); HEYUAN POCO NEW MATERIAL CO., LTD., Heyuan (CN)

(72) Inventors: Tao Luo, Shenzhen (CN); Xiongzhi Guo, Shenzhen (CN); Yunfan Zhang, ShenZhen (CN); Zhida Liu, ShenZhen (CN); Shaofei Wang, ShenZhen (CN)

(73) Assignees: HUIZHOU POCO NEW INDUCTOR TECHNOLOGY CO., LTD., Huizhou (CN); HEYUAN POCO NEW MATERIAL CO., LTD., Heyuan (CN)

(21) Appl. No.: 18/972,037

(22) Filed: Dec. 6, 2024

(30) Foreign Application Priority Data
Dec. 29, 2023 (CN) 202311862345.3

(51) Int. Cl. H01F 27/28; H01F 27/06

(52) U.S. Cl. CPC H01F 27/28; H01F 27/06

(57) ABSTRACT

Provided are a coupled dual winding structure and an inductor. The coupled dual winding structure includes an inner winding and an outer winding which are coupled to each other and are insulated from each other. The outer winding includes a through groove, the through groove penetrates through the outer winding in an extension direction of the through groove, and the inner winding is disposed within the through groove and penetrates through the through groove in the extension direction of the through groove, so that the magnetic force lines generated after the current flows through the inner winding pass through the outer winding to the maximum extent.

### CROSS-REFERENCE TO RELATED APPLICATION

This application claims priority to Chinese Patent Application No. 202311862345.3, filed on Dec. 29, 2023, the disclosure of which is incorporated herein by reference in its entirety.

### TECHNICAL FIELD

The present disclosure relates to the technical field of electronic components, and in particularly, to a coupled dual winding structure and an inductor.

### BACKGROUND

The combined coupled inductor is formed by assembling a magnetic core, a main winding and a coupled winding which are processed separately. The conventional coupling manner is not applicable to a trans-inductor voltage regulator (TLVR) inductor, and causes a problem of low coupling degree. The conventional coupling manner also has some problems that the interior of the inductor cannot be fully filled with a magnetic material, the magnetic material and the winding cannot be fully contacted, the power density is low, and the heat dissipation is insufficient.

In recent years, as the power requirement of a microprocessor has increased dramatically, the microprocessor is required to have a larger current with a higher slew rate, which requires a voltage regulator to have a faster dynamic response during a load transient to satisfy the output voltage ripple requirement. The trans-inductor voltage regulator (TLVR) architecture is a voltage regulator (VR) power supply architecture newly developed in recent years and can achieve the extremely fast load transient response. Compared with the conventional DC to DC buck architecture, the biggest difference is to replace the conventional ordinary single winding inductor with a transformer-like TLVR inductor having dual windings, where the TLVR inductor has four leads, and the dual windings are coupled to each other. In the related art, the dual windings used in TLVR are mostly simple U-shaped windings, and the coupling coefficient is relatively low when the dual winding are coupled to each other. The higher the coupling coefficient is, the faster the dynamic response is.

### SUMMARY

The present disclosure provides a coupled dual winding structure and an inductor, to solve the problem of low coupling degree of the coupled inductor in the related art, so that the coupling coefficient is up to more than 0.98.

According to an aspect of the present disclosure, a coupled dual winding structure is provided. The coupled dual winding structure includes an inner winding and an outer winding which are coupled to each other and are insulated from each other. The outer winding includes a through groove, the through groove penetrates through the outer winding in an extension direction of the through groove, and the inner winding is disposed within the through groove and penetrates through the through groove in the extension direction of the through groove.

In some embodiments, the outer winding includes a bottom plate, a first side plate, a second side plate and a third side plate. The first side plate, the second side plate and the third side plated are disposed on a same side of the bottom plate, the first side plate is connected to the second side plate, and the second side plate and the third side plate are disposed opposite to each other. The bottom plate is connected to the first side plate, the second side plate and the third side plate, and an accommodation space defined by the bottom plate, the first side plate, the second side plate and the third side plate is the through groove.

In some embodiments, the outer winding includes a first side plate, a second side plate and a third side plate, where the first side plate is connected to the second side plate, and the second side plate and the third side plate are disposed opposite to each other. The inner winding is disposed within an accommodation space defined by the first side plate, the second side plate and the third side plate.

In some embodiments, the inner winding includes a fifth side plate, a sixth side plate and a seventh side plate which are sequentially connected. The fifth side plate is located between the first side plate and the third side plate, the sixth side plate is located between the second side plate and the third side plate, and the seventh side plate is located on a side of the sixth side plate away from the first side plate.

In some embodiments, the outer winding further includes a fourth side plate, a first pin and a second pin, and the inner winding further includes a third pin and a fourth pin. The fourth side plate is connected to an end of the second side plate away from the first side plate, a combination of the first side plate, the second side plate and the fourth side plate is a U-shaped structure, the third side plate is located within the U-shaped structure, the first side plate is connected to the first pin, and the fourth side plate is connected to the second pin. A combined shape of the fifth side plate, the sixth side plate and the seventh side plate is U-shaped, the seventh side plate is located between the third side plate and the fourth side plate, the fifth side plate is connected to the third pin, and the seventh side plate is connected to the fourth pin. The first pin, the second pin, the third pin and the fourth pin are parallel to the first side plate; or an unconnected end of the first pin is bent towards a first direction, where the first direction is a direction in which the fourth side plate is directed towards the first side plate; an unconnected end of the second pin is bent towards a second direction, where the second direction is a direction in which the first side plate is directed towards the fourth side plate; an unconnected end of the third pin is bent towards the second direction; and an unconnected end of the fourth pin is bent towards the first direction.

In some embodiments, the outer winding further includes a fourth side plate, a first pin and a second pin, the inner winding further includes a third pin and a fourth pin, a combination of the first side plate and the second side plate is an L-shaped structure, the fourth side plate is connected to the third side plate, the third side plate is located within the L-shaped structure, the fourth side plate is located on a side of the third side plate away from the second side plate and is located on a side of the third side plate away from the first side plate, the first side plate is connected to the first pin, and the fourth side plate is connected to the second pin. The fifth side plate is located between the first side plate and the third side plate, the seventh side plate is located on a side of the sixth side plate adjacent to the second side plate, the fifth side plate is connected to the third pin, and the seventh side plate is connected to the fourth pin. An unconnected end of the first pin is bent towards a first direction, where the first direction is a direction in which the fourth side plate is directed towards the first side plate; an unconnected end of the second pin is bent towards the first direction; an unconnected end of the third pin is bent towards a second direction, where the second direction is a direction in which the first side plate is directed towards the fourth side plate; and an unconnected end of the fourth pin is bent towards the first direction.

In some embodiments, the outer winding further includes a fourth side plate, a first pin and a second pin, and the inner winding further includes a third pin and a fourth pin. The fourth side plate is connected to an end of the second side plate away from the first side plate, the fourth side plate is disposed on a side of the second side plate away from the third side plate, the first side plate is connected to the first pin, and the fourth side plate is connected to the second pin. The fifth side plate is located between the first side plate and the third side plate, the seventh side plate is located on a side of the sixth side plate adjacent to the second side plate, the fifth side plate is connected to the third pin, and the seventh side plate is connected to the fourth pin. An unconnected end of the first pin is bent towards a first direction, where the first direction is a direction in which the fourth side plate is directed towards the first side plate; an unconnected end of the second pin is bent towards the first direction; an unconnected end of the third pin is bent towards a second direction, where the second direction is a direction in which the first side plate is directed towards the fourth side plate; and an unconnected end of the fourth pin is bent towards the second direction.

In some embodiments, the outer winding further includes a fourth side plate, a first pin and a second pin, and the inner winding further includes a third pin and a fourth pin. The fourth side plate is connected to an end of the second side plate away from the first side plate, the fourth side plate is located at a side of the second side plate away from the third side plate, the first side plate is connected to the first pin, and the fourth side plate is connected to the second pin. A combined shape of the fifth side plate, the sixth side plate and the seventh side plate is U-shaped, the seventh side plate is located on a side of the sixth side plate adjacent to the third side plate, the fifth side plate is connected to the third pin, and the seventh side plate is connected to the fourth pin. An unconnected end of the first pin is bent towards a first direction, where the first direction is a direction in which the fourth side plate is directed towards the first side plate; an unconnected end of the second pin is bent towards the first direction; an unconnected end of the third pin is bent towards a second direction, where the second direction is a direction in which the first side plate is directed towards the fourth side plate; and an unconnected end of the fourth pin is bent towards the first direction.

In some embodiments, the outer winding includes a bottom plate, a first side plate, a second side plate and a fourth side plate, where the first side plate, the second side plate and the fourth side plate are disposed on the same side of the bottom plate and are sequentially connected, the bottom plate is connected to at least the first side plate and the second side plate, the inner winding includes a fifth side plate, a sixth side plate and a seventh side plate, where the fifth side plate, the sixth side plate, the seventh side plate and the first side plate are disposed on the same side of the bottom plate; the fifth side plate, the sixth side plate and the seventh side plate are sequentially connected; the sixth side plate and at least partial region of the fifth side plate are located in an accommodation space defined by the bottom plate, the first side plate and the second side plate, vertical projections of the sixth side plate and the at least partial region of the fifth side plate on the bottom plate are located within the bottom plate, and the seventh side plate is located on a side of the sixth side plate away from the first side plate.

According to an aspect of the present disclosure, an inductor is provided. The inductor includes a magnetic core and at least one coupled dual winding structure described in any of the embodiments of the present disclosure, where the coupled dual winding structure is partially disposed within the magnetic core, each of the inner winding and the outer winding includes a pin, and the pin is exposed out of the magnetic core and is connected to an external circuit. Preferably, the inductor is an integrally molded inductor. Preferably, an outer surface of at least one of the inner winding or the outer winding is wrapped with an insulating layer, and the inner winding is located within the through groove and abuts against a side wall of the through groove; or the inner winding is located within the through groove and is separated from a side wall of the through groove by the magnetic core.

According to the coupled dual winding structure provided in the technical solutions of the embodiments of the present disclosure. In this embodiment, the coupled dual winding structure includes the inner winding and the outer winding which are coupled to each other and are insulated from each other, the outer winding includes the through groove, the through grove penetrates through the outer winding in the extension direction of the through groove, the inner winding is disposed within the through groove and penetrates through the through groove in the extension direction of the through groove. In the present disclosure, the inner winding is disposed within the through groove, magnetic force lines generated after the current flows through the inner winding almost all have to pass through the outer winding, and the coupling coefficient can exceed 0.98, so that the almost full coupling is achieved, the quick response is achieved, and the loss is reduced.

It should be understood that the contents described in this section are not intended to identify key or critical features of the embodiments of the present disclosure, nor intended to limit the scope of the present disclosure. Other features of the present disclosure will be readily understood from the following description.

### BRIEF DESCRIPTION OF DRAWINGS

In order to describe technical solutions in embodiments of the present disclosure more clearly, drawings of the embodiments will be briefly described below. The drawings in the following description are merely some embodiments of the present disclosure. For those of ordinary skill in the art, other drawings may also be obtained without creative labor according to these drawings.

FIGS. 1 to 2 are perspective views of different structures of an inner winding and an outer winding according to an embodiment of the present disclosure.

FIG. 3 is a perspective view of an outer winding according to an embodiment of the present disclosure.

FIG. 4 is a perspective view of a structure of an inner winding and an outer winding without a bottom plate according to an embodiment of the present disclosure.

FIG. 5 is a perspective view of an inductor according to an embodiment of the present disclosure.

FIGS. 6 to 7 are internal perspective views of an inductor according to an embodiment of the present disclosure.

FIG. 8 is an internal perspective view of another inductor according to an embodiment of the present disclosure.

FIG. 9 is an internal perspective view of another inductor according to an embodiment of the present disclosure.

FIG. 10 is an internal perspective view of another inductor according to an embodiment of the present disclosure.

### DETAILED DESCRIPTION

In order that those skilled in the art will better understand the solutions of the present disclosure, the technical solutions adopted, and the technical effects to be achieved by the present disclosure, the technical solutions of embodiments of the present disclosure will be clearly and completely described below in conjunction with the accompanying drawings of the embodiments of the present disclosure. Apparently, the described embodiments are merely some embodiments of the present disclosure, rather than all of the embodiments. All other embodiments obtained by those of ordinary skill in the art based on the embodiments of the present disclosure without needing creative efforts shall all fall in the scope of protection of the present disclosure.

It should be noted that the terms “first”, “second” and the like in the present disclosure are used for distinguishing between similar objects and not necessarily for describing a particular order or sequential order. It should be understood that the data so used are interchangeable as appropriate so that the embodiments of the present disclosure described herein can be implemented in an order other than those illustrated or described herein. Moreover, the terms “include” and “have” as well as any variations thereof, are intended to cover a non-exclusive inclusion, for example, a process, a method, a system, a product, or a device that includes a series of steps or units is not necessarily limited to those steps or units expressly listed, but may include other steps or units not expressly listed or inherent to such process, method, product, or device.

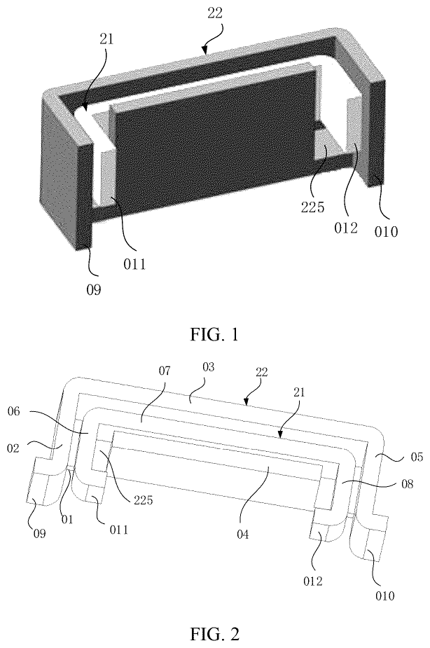

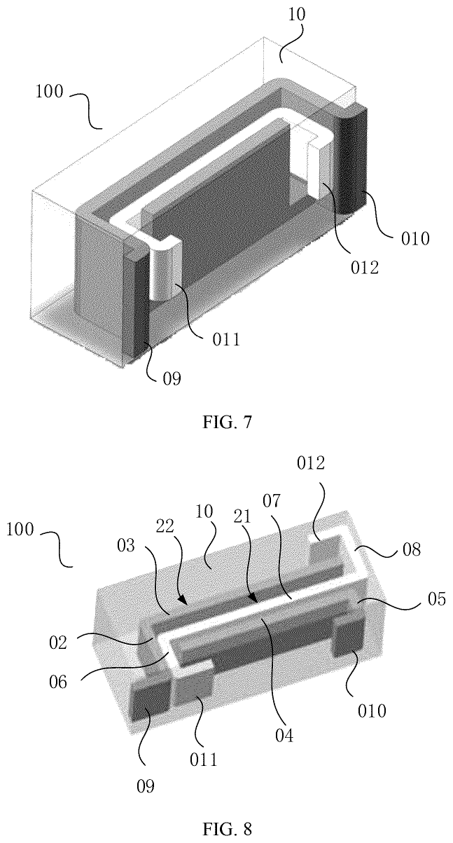

Referring to FIG. 1 to FIG. 10, an embodiment of the present disclosure provides a coupled dual winding structure and an inductor 100 including the coupled dual winding structure. The inductor 100 including the coupled dual winding structure is a trans-inductor voltage regulator (TLVR) structure. In an embodiment, the inductor may include a magnetic core 10 and a coupled dual winding structure disposed within the magnetic core 10. The inductor is formed by placing magnetic powder and the dual winding structure in a mold cavity and then pressing to make the magnetic powder and the dual winding structure integrally molded; or the inductor is formed by first pressing magnetic powder to form the magnetic core 10, and then assembling the magnetic core with the coupled dual winding structure.

In this embodiment, the coupled dual winding structure includes an inner winding 21 and an outer winding 22 which are coupled to each other and are insulated from each other. The outer winding 22 includes a through groove 225, and the through groove 225 penetrates through the outer winding 22 in an extension direction of the through groove 225. The inner winding 21 is disposed within the through groove 225 and penetrates through the through groove 225 in the extension direction of the through groove 225.

The inner winding 21 and the outer winding 22 are wrapped with a thin insulating film or are insulated by a magnet. Since the inner winding 21 is disposed within the through groove 225, the through groove 225 enables the outer winding 22 and the inner winding 21 to be magnetically coupled after the outer winding 22 and the inner winding 21 are energized, and magnetic force lines generated after the inner winding 21 is energized may pass through the outer winding 22 to the maximum extent, so that the electric field generated by the inner winding 21 may pass through the outer winding 22 to the maximum extent, thereby effectively improving a coupling coefficient of a device and improving the working efficiency of the device. Moreover, the through groove 225 may facilitate the placement of the inner winding 21; therefore, the manufacturing manner of the inductance device is simplified, facilitating the mass production in practice.

In an embodiment, the inner winding 21 is located inside the through groove 225, magnetic force lines generated after the current flows through the inner winding 21 almost all have to pass through the outer winding 22, the coupling characteristic thereof is close to the full coupling, that is, the coupling coefficient is close to 1. A spacing between the two windings is close enough, so that the very high coupling coefficient can be achieved, the almost full coupling can be achieved, and the coupling coefficient can exceed 0.98 and be close to 1, achieving the fast response. In addition, when the inductor 100 is an integrally molded inductor, a spacing between the inner winding 21 and an inner wall of the outer winding 22 may also be set to be close enough, thereby further improving the coupling coefficient.

According to the coupled dual winding structure provided in the technical solutions of the embodiments of the present disclosure, in this embodiment, the coupled dual winding structure includes the inner winding 21 and the outer winding 22 which are coupled to each other and are insulated from each other, the outer winding 22 includes the through groove 225, the through grove 225 penetrates through the outer winding 22 in the extension direction of the through groove 225, the inner winding 21 is disposed within the through groove 225 and penetrates through the through groove 225 in the extension direction of the through groove 225. In the present disclosure, the inner winding 21 is disposed within the through groove 225, the magnetic force lines generated after the current flows through the inner winding 21 almost all have to pass through the outer winding 22, and the coupling coefficient can exceed 0.98, so that the almost full coupling is achieved, the quick response is achieved, and the loss is reduced.

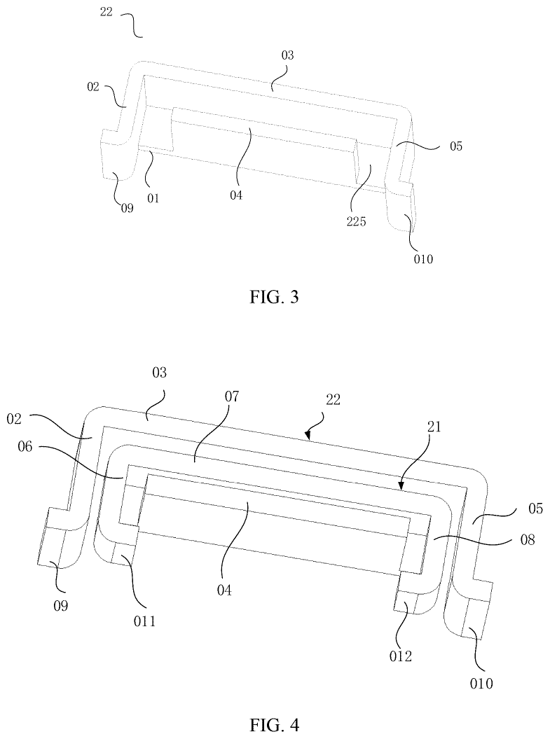

Optionally, referring to FIG. 3, the outer winding 22 includes a bottom plate 01, a first side plate 02, a second side plate 03 and a third side plate 04. The first side plate 01, the second side plate 02 and the third side plate 04 are disposed on the same side of the bottom plate 01. The first side plate 02 is connected to the second side plate 03, and the second side plate 03 and the third side plate 04 are disposed opposite to each other. The bottom plate 01 is connected to the first side plate 02, the second side plate 03 and the third side plate 04, and an accommodation space defined by the bottom plate 01, the first side plate 02, the second side plate 03 and the third side plate 04 is the through groove 225.

The second side plate 03 and the third side plate 04 may or may not be disposed in parallel. In the embodiments of the present disclosure, FIG. 3 only illustrates one shape of the through groove 225. The second side plate 03 and the third side plate 04 in FIG. 3 are disposed in parallel. In some embodiments, referring to FIG. 3, a shape of the accommodation space defined by the bottom plate 01, the first side plate 02, the second side plate 03 and the third side plate 04 may be “U”-shaped. The shape of the through groove 225 needs to ensure that the inner winding 21 may be accommodated inside the through groove 225, so that the outer winding 22 and the inner winding 21 may be magnetically coupled after the outer winding 22 and the inner winding 21 are energized, the magnetic force lines generated after the inner winding 21 is energized may pass through the outer winding 22 to the maximum extent, and an electric field generated by the inner winding 21 may pass through the outer winding 22 to the maximum extent, thereby effectively improving the coupling coefficient of the device and improving the working efficiency of the device.

Optionally, referring to FIG. 4, the outer winding 22 includes a first side plate 02, a second side plate 03 and a third side plate 04. The first side plate 02 is connected to the second side plate 03, and the second side plate 03 and the third side plate 04 are disposed opposite to each other. The inner winding 21 is disposed within the accommodation space defined by the first side plate 02, the second side plate 03 and the third side plate 04.

In FIG. 4, the second side plate 03 and the third side plate 04 may or may not be disposed in parallel. The second side plate 03 and the third side plate 04 in FIG. 4 are disposed in parallel. The difference between FIG. 4 and FIG. 2 in the above-described embodiments lies in that the outer winding 22 in FIG. 4 do not include the bottom plate 01, so that the magnetic force lines generated after the inner winding 21 is energized may pass through the accommodation space defined by the first side plate 02 of the outer winding 22, the second side plate 03 of the outer winding 22, and the third side plate 04 of the outer winding 22, thereby effectively improving the coupling coefficient of the device and improving the working efficiency of the device.

Optionally, referring to FIG. 1 to FIG. 4, the inner winding 21 includes a fifth side plate 06, a sixth side plate 07 and a seventh side plate 08. The fifth side plate 06, the sixth side plate 07 and the seventh side plate 08 are sequentially connected. The fifth side plate 06 is located between the first side plate 02 and the third side plate 04, the sixth side plate 07 is located between the second side plate 03 and the third side plate 04, and the seventh side plate 08 is located on a side of the sixth side plate 07 away from the first side plate 06.

In some embodiments, the fifth side plate 06 and the seventh side plate 08 in FIGS. 1 to 4 are disposed in parallel with the first side plate 02, and the sixth side plate 07 is disposed in parallel with the second side plate 03 and the third side plate 04. FIG. 1 to FIG. 4 are merely exemplary illustrations, the fifth side plate 06 and the seventh side plate 08 may not be disposed in parallel with the first side plate 02, and the sixth side plate 07 may not be disposed in parallel with the second side plate 03 and the third side plate 04. A shape of the inner winding 21 in FIG. 1 to FIG. 4 may be “U”-shaped, the shape of the inner winding 21 needs to ensure that the inner winding 21 may be located within the accommodation space formed by the outer winding 22, so that the outer winding 22 and the inner winding 21 may be magnetically coupled after the outer winding 22 and the inner winding 21 are energized. Moreover, the magnetic force lines generated after the inner winding 21 is energized can pass through the outer winding 22, so that an electric field generated by the inner winding 21 can pass through the outer winding 22 to the maximum extent, thereby effectively improving the coupling coefficient of the device, and improving the working efficiency of the device.

Optionally, referring to FIG. 1 and FIG. 4, the outer winding 22 further includes a fourth side plate 05, a first pin 09 and a second pin 010. The inner winding 21 further includes a third pin 011 and a fourth pin 012. The fourth side plate 05 is connected to an end of the second side plate 03 away from the first side plate 02, a combination of the first side plate 02, the second side plate 03 and the fourth side plate 05 is a U-shaped structure, and the third side plate 04 is located within the U-shaped structure. The first side plate 02 is connected to the first pin 09, and the fourth side plate 05 is connected to the second pin 010. A combined shape of the fifth side plate 06, the sixth side plate 07 and the seventh side plate 08 is U-shaped, and the seventh side plate 08 is located between the third side plate 04 and the fourth side plate 05. The fifth side plate 06 is connected to the third pin 011, and the seventh side plate 08 is connected to the fourth pin 012.

Each of the first pin 09, the second pin 010, the third pin 011 and the fourth pin 012 is parallel to the first side plate 02. An unconnected end of the first pin 09 is bent towards a first direction, where the first direction is a direction in which the fourth side plate 05 is directed towards the first side plate 02. An unconnected end of the second pin 010 is bent towards a second direction, where the second direction is a direction in which the first side plate 02 is directed towards the fourth side plate 05. An unconnected end of the third pin 011 is bent towards the second direction. An unconnected end of the fourth pin 012 is bent towards the first direction.

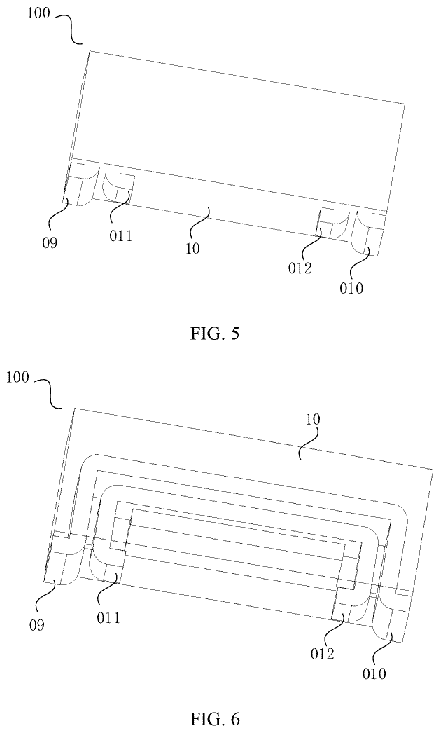

In FIG. 1 to FIG. 4, a pin of the outer winding 22 include the first pin 09 and the second pin 010, a pin of the inner winding 21 includes the third pin 011 and the fourth pin 012, and each of the first pin 09, the second pin 010, the third pin 011, and the fourth pin 012 is parallel to the first side plate 02 or is bent, which may be set according to practical requirements. In FIG. 5 to FIG. 7, the first pin 09, the second pin 010, the third pin 011 and the fourth pin 012 are all located on the same surface of the magnetic core 10. Structures of the outer windings 22 in FIG. 1 to FIG. 3 each include the bottom plate 01, and the fourth side plate 05, the first pin 09, the second pin 010 and the first side plate 02 are disposed on the same side of the bottom plate 01. The fourth side plate 05 is connected to the bottom plate 01, and the sixth side plate 07 and at least partial regions of the fifth side plate 06 and the seventh side plate 08 are located within the through groove 225. The structure in FIG. 4 does not include the bottom plate 01, and the sixth side plate 07 and at least partial regions of the fifth side plate 06 and the seventh side plate 08 are disposed within the accommodation space defined by the first side plate 02, the second side plate 03 and the third side plate 04. The structure of the outer winding 22 with or without the bottom plate 01 can effectively improve the coupling coefficient of the device and improve the working efficiency of the device.

Referring to FIG. 8, based on the above-described embodiments, an embodiment of the present disclosure further provides a coupled dual winding structure and an inductor 100 including the coupled dual winding structure. The outer winding 22 further includes a fourth side plate 05, a first pin 09 and a second pin 010. The inner winding 21 further includes a third pin 011 and a fourth pin 012. A combination of the first side plate 02 and the second side plate 03 is an L-shaped structure. The fourth side plate 05 is connected to the third side plate 04, the third side plate 04 is located within the L-shaped structure, the fourth side plate 05 is located on a side of the third side plate 04 away from the second side plate 03, and the fourth side plate 05 is located on a side of the third side plate 04 away from the first side plate 02. The first side plate 02 is connected to the first pin 09, and the fourth side plate 05 is connected to the second pins 010. The fifth side plate 06 is located between the first side plate 02 and the third side plate 04, and the seventh side plate 08 is located on a side of the sixth side plate 07 adjacent to the second side plate 03. The fifth side plate 06 is connected to the third pin 011, and the seventh side plate 08 is connected to the fourth pin 012.

A connected end of the first pin 09 is bent towards the first direction, and the first direction is the direction in which the fourth side plate 05 is directed towards the first side plate 02. An unconnected end of the second pin 010 is bent toward the first direction. An unconnected end of the third pin 011 is bent towards the second direction, and the second direction is the direction in which the first side plate 02 is directed towards the fourth side plate 05. The unconnected end of the fourth pin 012 is bent towards the first direction.

The shape of the accommodation space of the through groove in FIG. 8 may be “L”-shaped. The shape of the inner winding 21 in FIG. 8 may be “Z”-shaped. The first pin 09, the second pin 010 and the third pin 011 in FIG. 8 are all located on the same surface of the magnetic core 10, and the fourth pin 012 is located on an end surface opposite to the same surface, so that a vertical power supply inductor may be formed after it is energized, thereby being conducive to reducing the size of the device, facilitating the integration of the device, and also effectively preventing the short circuit during connection, where the outgoing line manner of the pin may be selected according to practical conditions.

In some embodiments, the structure of the outer winding 22 in FIG. 8 may or may not include the bottom plate. If the outer winding 22 includes the bottom plate, the fourth side plate 05, the first pin 09, the second pin 010 and the first side plate 02 are disposed on the same side of the bottom plate, the sixth side plate 07 and at least partial region of the fifth side plate 06 are located within the through groove, and the seventh side plate 08 is located outside the through groove. If the outer winding 22 does not include the bottom plate, the sixth side plate 07 and at least partial region of the fifth side plate 06 are disposed within the accommodation space defined by the first side plate 02, the second side plate 03 and the third side plate 04. The structure of the outer winding 22 with or without the bottom plate 01 can effectively improve the coupling coefficient of the device and improve the working efficiency of the device.

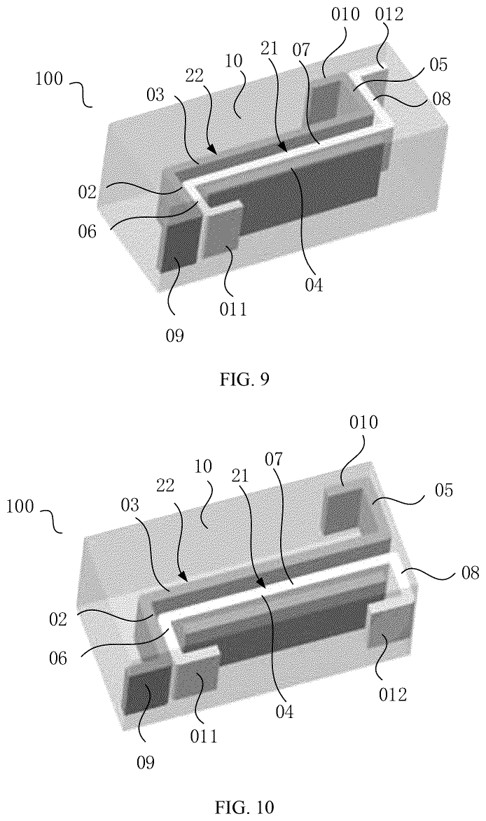

Referring to FIG. 9, based on the above-described embodiments, an embodiment of the present disclosure further provides a coupled dual winding structure and an inductor 100 including the coupled dual winding structure. The outer winding 22 further includes a fourth side plate 05, a first pin 09 and a second pin 010. The inner winding 21 further includes a third pin 011 and a fourth pin 012. The fourth side plate 05 is connected to the end of the second side plate 03 away from the first side plate 02, and the fourth side plate 05 is disposed on a side of the second side plate 03 away from the third side plate 04. The first side plate 02 is connected to the first pin 09, and the fourth side plate 05 is connected to the second pin 010. The fifth side plate 06 is located between the first side plate 02 and the third side plate 04, and the seventh side plate 08 is located on a side of the sixth side plate 07 adjacent to the second side plate 03. The fifth side plate 06 is connected to the third pin 011, and the seventh side plate 08 is connected to the fourth pin 012.

An unconnected end of the first pin 09 is bent towards the first direction, and the first direction is the direction in which the fourth side plate 05 is directed towards the first side plate 02. An unconnected end of the second pin 010 is bent towards the first direction. An unconnected end of the third pin 011 is bent towards the second direction, and the second direction is the direction in which the first side plate 02 is directed towards the fourth side plate 05. An unconnected end of the fourth pin 012 is bent towards the second direction.

The shape of the accommodation space of the through groove in FIG. 9 may be “L”-shaped. The shape of the inner winding 21 in FIG. 9 may be “Z”-shaped. The first pin 09 and the third pin 011 in FIG. 9 are all located on the same surface of the magnetic core 10, and the second pin 010 and the fourth pin 012 are located on an end surface opposite to the same surface, so that a vertical power supply inductor may be formed after it is energized, thereby being conducive to reducing the size of the device, facilitating the integration of the device, and also effectively preventing the short circuit during connection, where the outgoing line manner of the pin may be selected according to practical conditions.

In some embodiments, the structure of the outer winding 22 in FIG. 9 may or may not include the bottom plate. If the outer winding 22 includes the bottom plate, the fourth side plate 05, the first pin 09, the second pin 010 and the first side plate 02 are disposed on the same side of the bottom plate, the sixth side plate 07 and at least partial region of the fifth side plate 06 are located within the through groove, and the seventh side plate 08 is located outside the through groove. If the outer winding 22 does not include the bottom plate, the sixth side plate 07 and at least partial region of the fifth side plate 06 are disposed within the accommodation space defined by the first side plate 02, the second side plate 03 and the third side plate 04. The structure of the outer winding 22 with or without the bottom plate 01 can effectively improve the coupling coefficient of the device and improve the working efficiency of the device.

Referring to FIG. 10, based on the above-described embodiments, an embodiment of the present disclosure further provides a coupled dual winding structure and an inductor 100 including the coupled dual winding structure. The outer winding 22 further includes a fourth side plate 05, a first pin 09 and a second pin 010. The inner winding 21 further includes a third pin 011 and a fourth pin 012.

The fourth side plate 05 is connected to the end of the second side plate 03 away from the first side plate 02, and the fourth side plate 05 is located on the side of the second side plate 03 away from the third side plate 04. The first side plate 02 is connected to the first pin 09, and the fourth side plate 05 is connected to the second pin 010. The combined shape of the fifth side plate 06, the sixth side plate 07 and the seventh side plate 08 is U-shaped, and the seventh side plate 08 is located on a side of the sixth side plate 07 adjacent to the third side plate 04. The fifth side plate 06 is connected to the third pin 011, and the seventh side plate 08 is connected to the fourth pin 012.

An unconnected end of the first pin 09 is bent towards the first direction, and the first direction is the direction in which the fourth side plate 05 is directed towards the first side plate 02. An unconnected end of the second pin 010 is bent towards the first direction. An unconnected end of the third pin 011 is bent towards the second direction, and the second direction is the direction in which the first side plate 02 is directed towards the fourth side plate 05. An unconnected end of the fourth pin 012 is bent towards the first direction.

The shape of the accommodation space of the through groove in FIG. 10 may be “L”-shaped. The shape of the inner winding 21 in FIG. 10 may be “U”-shaped. The first pin 09, the second pin 010 and the third pin 011 in FIG. 10 are all located on the same surface of the magnetic core 10, and the fourth pin 012 is located on an end surface opposite to the same surface, so that a vertical power supply inductor may be formed after it is energized, thereby being conducive to reducing the size of the device, facilitating the integration of the device, and also effectively preventing the short circuit during connection, where the outgoing line manner of the pin may be selected according to practical conditions.

In some embodiments, the structure of the outer winding 22 in FIG. 10 may or may not include the bottom plate. If the outer winding 22 includes the bottom plate, the fourth side plate 05, the first pin 09, the second pin 010 and the first side plate 02 are disposed on the same side of the bottom plate, the sixth side plate 07 and at least partial region of the fifth side plate 06 are located in the through groove, and the seventh side plate 08 is located outside the through groove. If the outer winding 22 does not include the bottom plate, the sixth side plate 07 and at least partial regions of the fifth side plate 06 and the seventh side plate 08 are disposed within the accommodation space defined by the first side plate 02, the second side plate 03 and the third side plate 04. The structure of the outer winding 22 with or without the bottom plate 01 can effectively improve the coupling coefficient of the device and improve the working efficiency of the device.

Based on the above-described embodiments, an embodiment of the present disclosure further provides a coupled dual winding structure. The outer winding includes a bottom plate, a first side plate, a second side plate and a fourth side plate. The first side plate, the second side plate and the fourth side plate are disposed on the same side of the bottom plate. The first side plate, the second side plate and the fourth side plate are sequentially connected. The bottom plate is at least connected to the first side plate and the second side plate. The inner winding includes a fifth side plate, a sixth side plate and a seventh side plate. The fifth side plate, the sixth side plate, the seventh side plate and the first side plate are disposed on the same side of the bottom plate. The fifth side plate, the sixth side plate and the seventh side plate are sequentially connected. The sixth side plate and at least partial region of the fifth side plate are located within the accommodation space defined by the bottom plate, the first side plate and the second side plate. Vertical projections of the sixth side plate and the at least partial region of the fifth side plate on the bottom plate are located within the bottom plate, and the seventh side plate is located on a side of the sixth side plate away from the first side plate.

In some embodiments, the first side plate and the fourth side plate may or may not be disposed in parallel, the fifth side plate and the seventh side plate may or may not be disposed in parallel with the first side plate, and the sixth side plate and the second side plate may or may not be disposed in parallel.

Different from the above-described embodiments, in this embodiment of the present disclosure, the outer winding does not have the third side plate, so that the outer winding and the inner winding may be magnetically coupled after the outer winding and the inner winding are energized. The inner winding is located within the accommodation space defined by the bottom plate of the outer winding, the first side plate of the outer winding, and the second side plate of the outer winding, and the magnetic force lines generated after the inner winding is energized can pass through the outer winding, so that the electric field generated by the inner winding can pass through the outer winding, and the coupling coefficient of the device is effectively improved, and the working efficiency of the device is improved.

Based on the above-described embodiments, an embodiment of the present disclosure further provides an inductor. The inductor includes a magnetic core and at least one coupled dual winding structure described in any of the embodiments of the present disclosure. The coupled dual winding structure is partially disposed within the magnetic core, each of the inner winding and the outer winding includes a pin, and the pin is exposed out of the magnetic core and is connected to an external circuit. The magnetic core may be formed in following manners: a magnetic powder and the dual winding structure are placed in a mold cavity and are integrally formed by pressing; or a magnetic powder is firstly pressed to form the magnetic core, and then the magnetic core is assembled with the coupled dual winding structure.

In an embodiment, the inductor is an integrally molded inductor.

In an embodiment, an outer surface of at least one of the inner winding or the outer winding is wrapped with an insulating layer, and the inner winding is located within the through groove and abuts against a side wall of the through groove; or the inner winding is located within the through groove, and the inner winding is separated from a side wall of the through groove by the magnetic core.

The outer surface of the at least one of the inner winding or the outer winding is wrapped with the insulating layer, and the inner winding and the outer winding may be insulated from each other through the insulating layer; or the inner winding is separated from the side wall of the through groove by the magnetic core, and the inner winding and the outer winding are disposed to be insulated by the magnetic core.

The inductor provided in the embodiments of the present disclosure has the same beneficial effects as the coupled dual winding structure described in any of the embodiments of the present disclosure.

It is to be understood that various forms of the flows, the reordering step, the adding step or the deleting step shown above may be used. For example, as long as the desired results of the technical solutions of the present disclosure may be achieved, the steps recited in the present disclosure may be executed in parallel, sequentially or in different orders, which is not limited herein.

The above implementations should not be construed as limiting the scope of protection of the present disclosure. It is to be understood by those skilled in the art that various modifications, combinations, sub-combinations and substitutions may be made according to design requirements and other factors. Any modification, equivalent replacement, and improvement made within the spirit and the principle of the present disclosure should be included within the scope of protection of the present disclosure.

What is claimed is:

1. A coupled dual winding structure, comprising an inner winding and an outer winding which are coupled to each other and are insulated from each other,
wherein the outer winding comprises a through groove, the through groove penetrates through the outer winding in an extension direction of the through groove, and the inner winding is disposed within the through groove and penetrates through the through groove in the extension direction of the through groove.

2. The coupled dual winding structure of claim 1, wherein
the outer winding comprises a bottom plate, a first side plate, a second side plate and a third side plate, wherein the first side plate, the second side plate and the third side plated are disposed on a same side of the bottom plate, the first side plate is connected to the second side plate, and the second side plate and the third side plate are disposed opposite to each other; and
the bottom plate is connected to the first side plate, the second side plate and the third side plate, and an accommodation space defined by the bottom plate, the first side plate, the second side plate and the third side plate is the through groove.

3. The coupled dual winding structure of claim 1, wherein
the outer winding comprises a first side plate, a second side plate and a third side plate, wherein the first side plate is connected to the second side plate, and the second side plate and the third side plate are disposed opposite to each other; and
the inner winding is disposed within an accommodation space defined by the first side plate, the second side plate and the third side plate.

4. The coupled dual winding structure of claim 2, wherein
the inner winding comprises a fifth side plate, a sixth side plate and a seventh side plate which are sequentially connected; and
the fifth side plate is located between the first side plate and the third side plate, the sixth side plate is located between the second side plate and the third side plate, and the seventh side plate is located on a side of the sixth side plate away from the first side plate.

5. The coupled dual winding structure of claim 3, wherein
the inner winding comprises a fifth side plate, a sixth side plate and a seventh side plate which are sequentially connected; and
the fifth side plate is located between the first side plate and the third side plate, the sixth side plate is located between the second side plate and the third side plate, and the seventh side plate is located on a side of the sixth side plate away from the first side plate.

6. The coupled dual winding structure of claim 4, wherein
the outer winding further comprises a fourth side plate, a first pin and a second pin, and the inner winding further comprises a third pin and a fourth pin;
the fourth side plate is connected to an end of the second side plate away from the first side plate, a combination of the first side plate, the second side plate and the fourth side plate is a U-shaped structure, the third side plate is located within the U-shaped structure, the first side plate is connected to the first pin, and the fourth side plate is connected to the second pin;
a combined shape of the fifth side plate, the sixth side plate and the seventh side plate is U-shaped, the seventh side plate is located between the third side plate and the fourth side plate, the fifth side plate is connected to the third pin, and the seventh side plate is connected to the fourth pin; and
the first pin, the second pin, the third pin and the fourth pin are parallel to the first side plate; or
an unconnected end of the first pin is bent towards a first direction, wherein the first direction is a direction in which the fourth side plate is directed towards the first side plate; an unconnected end of the second pin is bent towards a second direction, wherein the second direction is a direction in which the first side plate is directed towards the fourth side plate; an unconnected end of the third pin is bent towards the second direction; and an unconnected end of the fourth pin is bent towards the first direction.

7. The coupled dual winding structure of claim 4, wherein
the outer winding further comprises a fourth side plate, a first pin and a second pin, the inner winding further comprises a third pin and a fourth pin, a combination of the first side plate and the second side plate is an L-shaped structure, the fourth side plate is connected to the third side plate, the third side plate is located within the L-shaped structure, the fourth side plate is located on a side of the third side plate away from the second side plate and is located on a side of the third side plate away from the first side plate, the first side plate is connected to the first pin, and the fourth side plate is connected to the second pin;
the fifth side plate is located between the first side plate and the third side plate, the seventh side plate is located on a side of the sixth side plate adjacent to the second side plate, the fifth side plate is connected to the third pin, and the seventh side plate is connected to the fourth pin; and
an unconnected end of the first pin is bent towards a first direction, wherein the first direction is a direction in which the fourth side plate is directed towards the first side plate; an unconnected end of the second pin is bent towards the first direction; an unconnected end of the third pin is bent towards a second direction, wherein the second direction is a direction in which the first side plate is directed towards the fourth side plate; and an unconnected end of the fourth pin is bent towards the first direction.

8. The coupled dual winding structure of claim 4, wherein
the outer winding further comprises a fourth side plate, a first pin and a second pin, and the inner winding further comprises a third pin and a fourth pin;
the fourth side plate is connected to an end of the second side plate away from the first side plate, the fourth side plate is disposed on a side of the second side plate away from the third side plate, the first side plate is connected to the first pin, and the fourth side plate is connected to the second pin;
the fifth side plate is located between the first side plate and the third side plate, the seventh side plate is located on a side of the sixth side plate adjacent to the second side plate, the fifth side plate is connected to the third pin, and the seventh side plate is connected to the fourth pin; and
an unconnected end of the first pin is bent towards a first direction, wherein the first direction is a direction in which the fourth side plate is directed towards the first side plate; an unconnected end of the second pin is bent towards the first direction; an unconnected end of the third pin is bent towards a second direction, wherein the second direction is a direction in which the first side plate is directed towards the fourth side plate; and an unconnected end of the fourth pin is bent towards the second direction.

9. The coupled dual winding structure of claim 4, wherein
the outer winding further comprises a fourth side plate, a first pin and a second pin, and the inner winding further comprises a third pin and a fourth pin;
the fourth side plate is connected to an end of the second side plate away from the first side plate, the fourth side plate is located at a side of the second side plate away from the third side plate, the first side plate is connected to the first pin, and the fourth side plate is connected to the second pin;
a combined shape of the fifth side plate, the sixth side plate and the seventh side plate is U-shaped, the seventh side plate is located on a side of the sixth side plate adjacent to the third side plate, the fifth side plate is connected to the third pin, and the seventh side plate is connected to the fourth pin; and
an unconnected end of the first pin is bent towards a first direction, wherein the first direction is a direction in which the fourth side plate is directed towards the first side plate; an unconnected end of the second pin is bent towards the first direction; an unconnected end of the third pin is bent towards a second direction, wherein the second direction is a direction in which the first side plate is directed towards the fourth side plate; and an unconnected end of the fourth pin is bent towards the first direction.

10. The coupled dual winding structure of claim 1, wherein
the outer winding comprises a bottom plate, a first side plate, a second side plate and a fourth side plate, wherein the first side plate, the second side plate and the fourth side plate are disposed on a same side of the bottom plate and are sequentially connected, the bottom plate is connected to at least the first side plate and the second side plate, the inner winding comprises a fifth side plate, a sixth side plate and a seventh side plate, wherein the fifth side plate, the sixth side plate, the seventh side plate and the first side plate are disposed on the same side of the bottom plate; the fifth side plate, the sixth side plate and the seventh side plate are sequentially connected; the sixth side plate and at least partial region of the fifth side plate are located in an accommodation space defined by the bottom plate, the first side plate and the second side plate, vertical projections of the sixth side plate and the at least partial region of the fifth side plate on the bottom plate are located within the bottom plate, and the seventh side plate is located on a side of the sixth side plate away from the first side plate.

11. An inductor, comprising:
a magnetic core and at least one coupled dual winding structure,
wherein a coupled dual winding structure of the at least one coupled dual winding structure comprises an inner winding and an outer winding which are coupled to each other and are insulated from each other,
wherein the outer winding comprises a through groove, the through groove penetrates through the outer winding in an extension direction of the through groove, and the inner winding is disposed within the through groove and penetrates through the through groove in the extension direction of the through groove; and
wherein the at least one coupled dual winding structure is partially disposed within the magnetic core, each of the inner winding and the outer winding comprises a pin, and the pin is exposed outside the magnetic core.

12. The inductor of claim 11, wherein the inductor is an integrally molded inductor.

13. The inductor of claim 11, wherein an outer surface of at least one of the inner winding or the outer winding is wrapped with an insulating layer, and the inner winding is located within the through groove and abuts against a side wall of the through groove; or the inner winding is located within the through groove and is separated from a side wall of the through groove by the magnetic core.

14. The inductor of claim 11, wherein
the outer winding comprises a bottom plate, a first side plate, a second side plate and a third side plate, wherein the first side plate, the second side plate and the third side plated are disposed on a same side of the bottom plate, the first side plate is connected to the second side plate, and the second side plate and the third side plate are disposed opposite to each other; and
the bottom plate is connected to the first side plate, the second side plate and the third side plate, and an accommodation space defined by the bottom plate, the first side plate, the second side plate and the third side plate is the through groove.

15. The inductor of claim 11, wherein
the outer winding comprises a first side plate, a second side plate and a third side plate, wherein the first side plate is connected to the second side plate, and the second side plate and the third side plate are disposed opposite to each other; and
the inner winding is disposed within an accommodation space defined by the first side plate, the second side plate and the third side plate.

16. The inductor of claim 14, wherein
the inner winding comprises a fifth side plate, a sixth side plate and a seventh side plate which are sequentially connected; and
the fifth side plate is located between the first side plate and the third side plate, the sixth side plate is located between the second side plate and the third side plate, and the seventh side plate is located on a side of the sixth side plate away from the first side plate.

17. The inductor of claim 15, wherein
the inner winding comprises a fifth side plate, a sixth side plate and a seventh side plate which are sequentially connected; and
the fifth side plate is located between the first side plate and the third side plate, the sixth side plate is located between the second side plate and the third side plate, and the seventh side plate is located on a side of the sixth side plate away from the first side plate.

18. The inductor of claim 16, wherein
the outer winding further comprises a fourth side plate, a first pin and a second pin, and the inner winding further comprises a third pin and a fourth pin;
the fourth side plate is connected to an end of the second side plate away from the first side plate, a combination of the first side plate, the second side plate and the fourth side plate is a U-shaped structure, the third side plate is located within the U-shaped structure, the first side plate is connected to the first pin, and the fourth side plate is connected to the second pin;
a combined shape of the fifth side plate, the sixth side plate and the seventh side plate is U-shaped, the seventh side plate is located between the third side plate and the fourth side plate, the fifth side plate is connected to the third pin, and the seventh side plate is connected to the fourth pin; and
the first pin, the second pin, the third pin and the fourth pin are parallel to the first side plate; or
an unconnected end of the first pin is bent towards a first direction, wherein the first direction is a direction in which the fourth side plate is directed towards the first side plate; an unconnected end of the second pin is bent towards a second direction, wherein the second direction is a direction in which the first side plate is directed towards the fourth side plate; an unconnected end of the third pin is bent towards the second direction; and an unconnected end of the fourth pin is bent towards the first direction.

19. The inductor of claim 16, wherein
the outer winding further comprises a fourth side plate, a first pin and a second pin, and the inner winding further comprises a third pin and a fourth pin;
the fourth side plate is connected to an end of the second side plate away from the first side plate, the fourth side plate is disposed on a side of the second side plate away from the third side plate, the first side plate is connected to the first pin, and the fourth side plate is connected to the second pin;
the fifth side plate is located between the first side plate and the third side plate, the seventh side plate is located on a side of the sixth side plate adjacent to the second side plate, the fifth side plate is connected to the third pin, and the seventh side plate is connected to the fourth pin; and
an unconnected end of the first pin is bent towards a first direction, wherein the first direction is a direction in which the fourth side plate is directed towards the first side plate; an unconnected end of the second pin is bent towards the first direction; an unconnected end of the third pin is bent towards a second direction, wherein the second direction is a direction in which the first side plate is directed towards the fourth side plate; and an unconnected end of the fourth pin is bent towards the second direction.

20. The inductor of claim 16, wherein
the outer winding further comprises a fourth side plate, a first pin and a second pin, and the inner winding further comprises a third pin and a fourth pin;
the fourth side plate is connected to an end of the second side plate away from the first side plate, the fourth side plate is located at a side of the second side plate away from the third side plate, the first side plate is connected to the first pin, and the fourth side plate is connected to the second pin;
a combined shape of the fifth side plate, the sixth side plate and the seventh side plate is U-shaped, the seventh side plate is located on a side of the sixth side plate adjacent to the third side plate, the fifth side plate is connected to the third pin, and the seventh side plate is connected to the fourth pin; and
an unconnected end of the first pin is bent towards a first direction, wherein the first direction is a direction in which the fourth side plate is directed towards the first side plate; an unconnected end of the second pin is bent towards the first direction; an unconnected end of the third pin is bent towards a second direction, wherein the second direction is a direction in which the first side plate is directed towards the fourth side plate; and an unconnected end of the fourth pin is bent towards the first direction.
